(19) United States
(12) Patent Application Publication
(10) Pub. No.: US 2025/0060499 A1
(43) Pub. Date: Feb. 20, 2025

(54) METHOD FOR REAL-TIME FRACTURES DETECTION USING DRILL BIT AS SOURCE

(71) Applicant: ARAMCO SERVICES COMPANY, Houston, TX (US)

(72) Inventors: Farhan Naseer, Houston, TX (US); Ammar AlQatari, Dhahran (SA); Weichang Li, Houston, TX (US)

(73) Assignees: ARAMCO SERVICES COMPANY, Houston, TX (US); SAUDI ARABIAN OIL COMPANY, Dhahran (SA)

(21) Appl. No.: 18/450,174

(22) Filed: Aug. 15, 2023

(51) Int. Cl. G01V 1/50; E21B 47/013; E21B 49/00; G01V 1/143; G06N 20/00

(52) U.S. Cl. CPC G01V 1/50; E21B 47/013; E21B 49/00; G01V 1/143; G06N 20/00; E21B 2200/20; E21B 2200/22; G01V 2210/6222

(57) ABSTRACT

Methods and systems for training a machine learning (ML) network to predict a likelihood of a presence of a geological fracture from an observed drill-bit seismic dataset are disclosed. The method may include obtaining, using a seismic processing system, a plurality of geophysical models, where each geophysical model includes a location of a drill bit. The method may further include simulating, for each geophysical model a corresponding simulated drill-bit seismic dataset for seismic waves emanating from the drill bit and recorded by at least one seismic receiver and forming a training dataset including a plurality of training pairs, with each training pair including a geophysical model from the plurality of geophysical models and the corresponding simulated drill-bit seismic dataset. The method may still further include training, using the training dataset, the ML network to predict the likelihood of the presence of the geological fracture from the observed drill-bit seismic dataset.

### BACKGROUND

Natural and drilling-induced fractures can pose serious hazards during drilling operations. Hitting fracture corridors during drilling operations can cause the loss of drilling fluid from the wellbore, which may be referred to as “lost circulation”. Drilling fluids may perform three key functions: flushing out drilling cuttings, cooling a lubricating the drill bit, and stabilizing uncased boreholes. A loss in drilling fluid circulation can result in non-productive time (NPT) or even in complete well loss, resulting in enormous costs. While regional tectonic stress analysis and offset well logs can estimate potential fracture cluster zones, these techniques cannot identify precise locations of open fractures near or ahead of the drill bit.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments disclosed herein relate to a method for training a machine learning (ML) network to predict a likelihood of a presence of a geological fracture from an observed drill-bit seismic dataset. The method may include obtaining, using a seismic processing system, a plurality of geophysical models, where each geophysical model includes a location of a drill bit and simulating, using the seismic processing system, for each geophysical model a corresponding simulated drill-bit seismic dataset for seismic waves emanating from the drill bit and recorded by at least one seismic receiver. The method may further include forming a training dataset including a plurality of training pairs, where each training pair includes a geophysical model from the plurality of geophysical models and the corresponding simulated drill-bit seismic dataset, and training, using the training dataset, the ML network to predict the likelihood of the presence of the geological fracture from the observed drill-bit seismic dataset.

In general, in one aspect, embodiments disclosed herein relate to a system for training a machine learning (ML) network to predict a likelihood of a presence of a geological fracture from an observed drill-bit seismic dataset. The system may include a drilling system comprising a drillstring and a drill bit, and a seismic processing system. The seismic processing system may be configured to receive a plurality of geophysical models, wherein each geophysical model includes a location of the drill bit and simulate, for each geophysical model a corresponding simulated drill-bit seismic dataset for seismic waves emanating from the drill bit and recorded by at least one seismic receiver, The seismic acquisition system may be further configured to form a training dataset including a plurality of training pairs, where each training pair comprises a geophysical model from the plurality of geophysical models and the corresponding simulated drill-bit seismic dataset. The system may further include a ML network, configured to be trained to predict the likelihood of the presence of the geological fracture from the observed drill-bit seismic dataset and a seismic acquisition system, configured to obtain the observed drill-bit seismic dataset for a subterranean region of interest.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The size and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements and have been solely selected for ease of recognition in the drawing.

FIG. 1 shows a drilling system in accordance with one or more embodiments.

FIG. 2 shows a machine learning (ML) network in accordance with one or more embodiments.

FIG. 3 shows a flow chart in accordance with one or more embodiments.

FIG. 4 shows a computer system in accordance with one or more embodiments.

FIG. 5 shows a flowchart of a method in accordance with one or more embodiments.

FIG. 6 shows a flowchart of a method in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily obscuring descriptions of the implementations and embodiments. For the sake of continuity, and in the interest of conciseness, same or similar reference characters may be used for same or similar objects in multiple figures.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to an “on-demand electrode” includes reference to one or more of such on-demand electrodes.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the method may be omitted, repeated, and/or performed in a different order than the order shown. Accordingly, the scope disclosed herein should not be considered limited to the specific arrangement of steps shown in the method.

Although multiple dependent claims are not introduced, it would be apparent to one of ordinary skill that the subject matter of the dependent claims of one or more embodiments may be combined with other dependent claims.

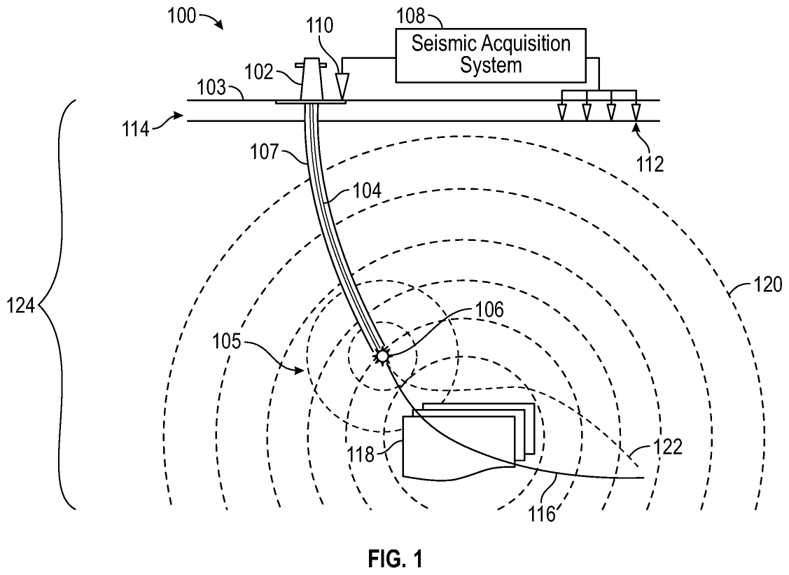

In the following description of FIGS. 1-6, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Disclosed herein are embodiments of systems and methods for using seismic energy radiating from a rotating drill bit to identify geological fractures in a formation, in particular geological fracture not yet intersected by the wellbore. Further, disclosed herein are embodiments of methods of using machine learning (ML) or artificial intelligence (AI) to identify the presence of diffractions in seismic data and to isolate diffraction events using traditional seismic processing techniques. The ability to detect geological fractures ahead of the drill bit and to make proactive alterations to the planned well trajectory represents an improvement over existing, reactive, well trajectory modification and mud loss mitigation techniques.

FIG. 1 depicts a drilling system 100 in accordance with one or more embodiments. The drilling system 100 may include a drilling rig 102 positioned on the surface of the earth 103. A drillstring 104 may extend from the drilling rig 102, through a wellbore 107 penetrating the subsurface 124, that may include a weathered layer 114 and a drill bit 106 may be disposed at the end of the drillstring 104.

In one or more embodiments, radiating seismic energy 105 may be produced by action of the drill bit 106 as it drills through the subsurface 124 rock to extend the length of the wellbore 107. Prior to drilling a wellbore, a well trajectory may be planned based upon the location of a drilling target, known or potential drill rig sites on the surface of the earth 103 and information about the subsurface 124. For example, a hydrocarbon reservoir may be targeted by the well trajectory. The wellbore trajectory may be planned using a well planning system.

The wellbore planning system may use information regarding the drilling target to plan a well, including a well trajectory from the surface of the earth 103 to reach or penetrate the target. In addition, to the depth and geographic location of the drilling target, the planned well trajectory may be constrained by surface limitations, such as suitable locations for the surface position of the wellhead, i.e., the location of potential or preexisting drilling rig, drilling ships or from a natural or man-made island. In addition, to the wellhead and drilling target locations a well trajectory may be influenced by drilling hazards, such as gas pockets, or subterranean water flows, and geological fractures and faults. Further the well trajectory may be constrained by limitations of the available drilling systems, e.g., the maximum curvature (“dog-leg”) that the drillstring may tolerate, and the maximum torque and drag that the available drilling system may overcome. A wellbore planning system, composed of one or more computer systems and appropriate wellbore planning software may be used to plan the well trajectory. The wellbore planning system may further determined planned wellbore caliper changes as a function of depth and the associated placement of casing (“casing points”) to provide mechanical support for the wellbore during and after drilling and the protection of the wellbore from the undesired influx of formation fluids into the wellbore.

Typically, the wellbore plan is generated based on best available information at the time of planning from a geophysical model, geomechanical models encapsulating subterranean stress conditions, the trajectory of any existing wellbores (which it may be desirable to avoid), and the existence of other drilling hazards, such as shallow gas pockets, over-pressure zones, and active fault planes.

The wellbore plan may be updated during the drilling of the wellbore. For example, the wellbore plan may be updated based upon new data about the condition of the drilling equipment, and about the subterranean region through which the wellbore is drilled, such as the presence of previously undetected geological fractures.

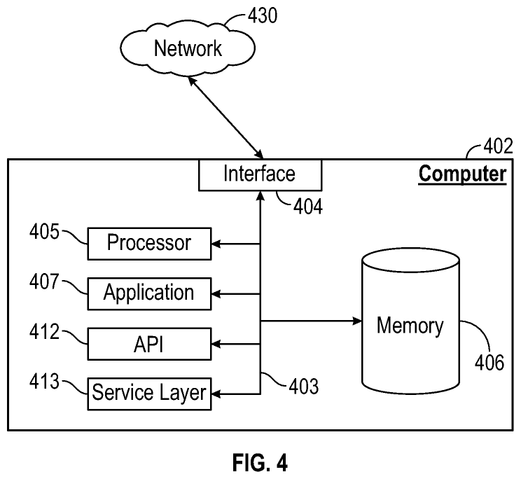

The wellbore planning system may include computer systems, such as the computer system described in FIG. 4, and may further include dedicated software to determine the planned wellbore path and associated drilling parameters, such as the planned wellbore diameter, the location of planned changes of the wellbore diameter, the planned depths at which casing will be inserted to support the wellbore and to prevent formation fluids entering the wellbore, and the drilling mud weights (densities) and types that may be used during drilling the wellbore.

Information regarding the planned wellbore and well trajectory may be transferred to the drilling system (100) described in FIG. 1. The drill bit 106 may be guided by an original well trajectory 116. However, in some cases the original well trajectory 116 may pass through one or more hitherto undetected geological fractures 118. In one or more embodiments, radiating seismic energy 105 may interact with the hitherto undetected geological fractures 118 and create diffracted waves 120 that may propagate to the surface of the earth 103.

In one or more embodiments, a seismic acquisition system 108 may be positioned on the surface of the earth 103. The seismic acquisition system 108 may include a pilot sensor 110 disposed on the drilling rig 102 and in vibrational communication with the drillstring 104. More specifically, the pilot sensor 110 may be in acoustic contact with the drillstring 104 and able to detect vibrations generated by the drill bit 106 and propagating up the drillstring 104. The seismic acquisition system 108 may also include three-component seismic receivers 112. In one or more embodiments, the three-component seismic receivers 112 may be located in a weathered layer 114 beneath the surface of the earth 103 or, alternatively, attached to the surface of the earth 103.

Machine learning (ML), broadly defined, is the extraction of patterns and insights from data. The phrases “artificial intelligence,” “machine learning,” “deep learning,” and “pattern recognition” are often convoluted, interchanged, and used synonymously. This ambiguity arises because the field of “extracting patterns and insights from data” was developed simultaneously and disjointedly among a number of classical arts like mathematics, statistics, and computer science. For consistency, the term machine learning. or machine learned, will be adopted herein. However, one skilled in the art will recognize that the concepts and methods detailed hereafter are not limited by this choice of nomenclature.

In some embodiments, the ML model may be a recurrent convolutional neural network (RCNN), such as the Pixel convolutional neural network (PixelCNN). An RCNN may be more readily understood as a specialized neural network (NN) and, from there, as a specialized convolutional neural network (CNN). Thus, a cursory introduction to an NN and a CNN are provided herein. However, note that many variations of an NN and CNN exist. Therefore, one of ordinary skill in the art will recognize that any variation of an NN or CNN (or any other ML model) may be employed without departing from the scope of this disclosure. Further, it is emphasized that the following discussions of an NN and CNN are basic summaries and should not be considered limiting.

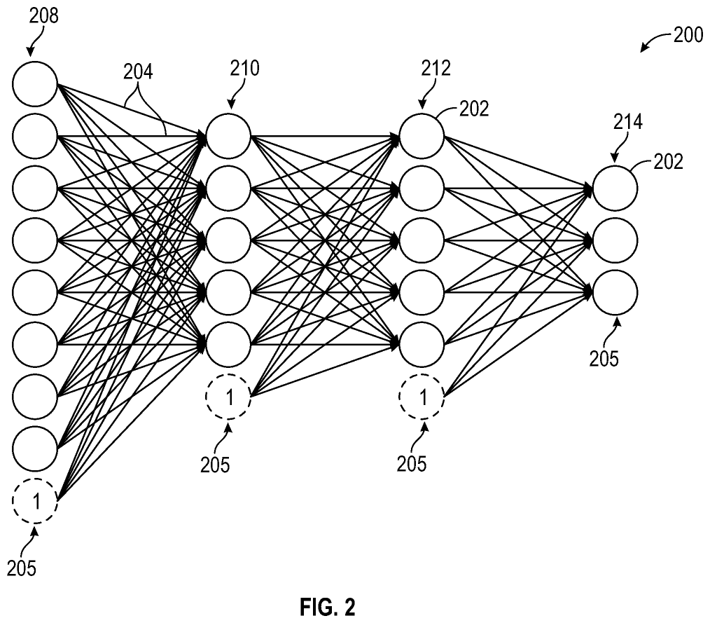

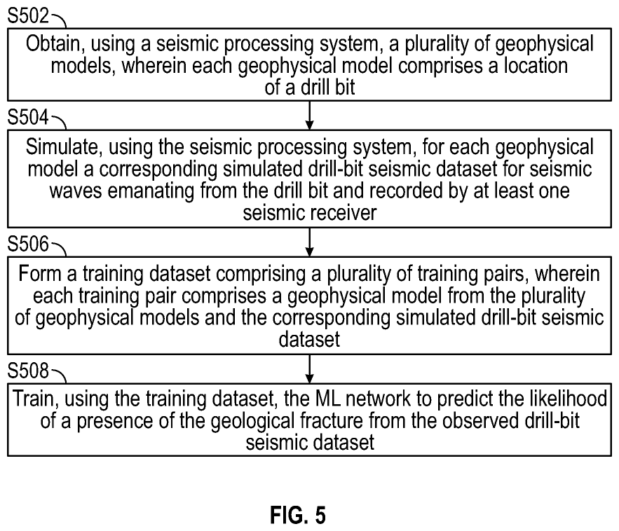

A diagram of an NN is shown in FIG. 2. At a high level, an NN 200 may be graphically depicted as being composed of nodes 202 and edges 204. The nodes 202 may be grouped to form layers 205. FIG. 5 displays four layers 208, 210, 212, 214 of nodes 202 where the nodes 202 are grouped into columns. However, each group need not be as shown in FIG. 2. The edges 204 connect the nodes 202 to other nodes 202. Edges 204 may connect, or not connect, to any node(s) 202 regardless of which layer 205 the node(s) 202 is in. That is, the nodes 202 may be sparsely and residually connected. For example, in a recurrent neural network (RNN), nodes 202 in the output layer 214 may be connected by edges 204 to nodes 202 in the input layer 208 (though not shown in FIG. 2).

An NN 200 will have at least two layers 205, where the first layer 208 is the “input layer” and the last layer 214 is the “output layer.” Any intermediate layer 210, 212 is usually described as a “hidden layer.” An NN 200 may have zero or more hidden layers 210, 212. An NN 200 with at least one hidden layer 210, 212 may be described as a “deep” neural network or “deep learning method.” In general, an NN 200 may have more than one node 202 in the output layer 214. In these cases, the neural network 200 may be referred to as a “multi-target” or “multi-output” network.

Nodes 202 and edges 204 carry associations. Namely, every edge 204 is associated with a numerical value. The edge numerical values, or even the edges 204 themselves, are often referred to as “weights” or “parameters.” While training an NN 200, a process that will be described below, numerical values are assigned to each edge 204. Additionally, every node 202 is associated with a numerical value and may also be associated with an activation function. Activation functions are not limited to any functional class, but traditionally follow the form:

$$A = f ( {\sum }_{i ∈ ( incoming )} [ {( node value )}_{i} {( edge value )}_{i} ] ) , \qquad Equation ( 1 )$$

where i is an index that spans the set of “incoming” nodes 202 and edges 204 and ƒ is a user-defined function. Incoming nodes 202 are those that, when viewed as a graph (as in FIG. 2), have directed arrows that point to the node 202 where the numerical value is being computed. Some functions ƒ may include the linear function ƒ(x)=x, sigmoid function

$$f ( x ) = \frac{1}{1 + {e}^{- x}} ,$$

and rectified linear unit function ƒ(x)=max(0, x), however, many additional functions are commonly employed. Every node 202 in an NN 200 may have a different associated activation function. Often, as a shorthand, activation functions are described by the function ƒ by which it is composed. That is, an activation function composed of a linear function ƒ may simply be referred to as a linear activation function without undue ambiguity.

When the NN 200 receives an input, the input is propagated through the network according to the activation functions and incoming node values and edge values to compute a value for each node 202. That is, the numerical value for each node 202 may change for each received input while the edge values remain unchanged. Occasionally, nodes 202 are assigned fixed numerical values, such as the value of 1. These fixed nodes 206 are not affected by the input or altered according to edge values and activation functions. Fixed nodes 206 are often referred to as “biases” or “bias nodes” as displayed in FIG. 2 with a dashed circle.

In some implementations, the NN 200 may contain specialized layers 205, such as a normalization layer, pooling layer, or additional connection procedures, like concatenation. One skilled in the art will appreciate that these alterations do not exceed the scope of this disclosure.

The number of layers in an NN 200, choice of activation functions, inclusion of batch normalization layers, and regularization strength, among others, may be described as “hyperparameters” that are associated to the ML model. It is noted that in the context of ML, the regularization of a ML model refers to a penalty applied to the loss function of the ML model. The selection of hyperparameters associated to a ML model is commonly referred to as selecting the ML model “architecture.”

Once a ML model, such as an NN 200, and associated hyperparameters have been selected, the ML model may be trained. To do so, M training pairs may be provided to the NN 200, where M is an integer greater than or equal to one. The variable m maintains a count of the M training pairs. As such, m is an integer between 1 and M inclusive of 1 and M where m is the current training pair of interest. For example, if M=2, the two training pairs include a first training pair and a second training pair each of which may be generically denoted an mth training pair. In general, each of the M training pairs includes an input and an associated target output. Each associated target output represents the “ground truth,” or the otherwise desired output upon processing the input. During training, the NN 200 processes at least one input from an mth training pair in the form of an mth training geological data patch to produce at least one output. Each NN output is then compared to the associated target output from the mth training pair in the form of an mth training feature image patch.

Returning to the NN 200 in FIG. 2, the NN 200 may be trained by first assigning initial values to the edges 204. These values may be assigned randomly, according to a prescribed distribution, manually, or by some other assignment mechanism. Once edge values have been initialized, the NN 200 may act as a function such that it may receive an input from an mth training pair and produce an output. At least one input is propagated through the neural network 200 to produce an output. The M training pairs will be discussed in more detail below.

The comparison of the NN output to the associated target output from the mth training pair is typically performed by a “loss function.” Other names for this comparison function include an “error function,” “misfit function,” and “cost function.” Many types of loss functions are available, such as the log-likelihood function. However, the general characteristic of a loss function is that the loss function provides a numerical evaluation of the similarity between the NN output and the associated target output from the mth training pair. The loss function may also be constructed to impose additional constraints on the values assumed by the edges 204. For example, a penalty term, which may be physics-based, or a regularization term may be added. Generally, the goal of a training procedure is to alter the edge values to promote similarity between the NN output and associated target output for most, if not all, of the M training pairs. Thus, the loss function is used to guide changes made to the edge values. This process is typically referred to as “backpropagation.”

While a full review of the backpropagation process exceeds the scope of this disclosure, a brief summary is provided. Backpropagation consists of computing the gradient of the loss function over the edge values. The gradient indicates the direction of change in the edge values that results in the greatest change to the loss function. Because the gradient is local to the current edge values, the edge values are typically updated by a “step” in the direction indicated by the gradient. The step size is often referred to as the “learning rate” and need not remain fixed during the training process. Additionally, the step size and direction may be informed by previous edge values or previously computed gradients. Such methods for determining the step direction are usually referred to as “momentum” based methods.

Once the edge values of the NN 200 have been updated through the backpropagation process, the NN 200 will likely produce different outputs than it did previously. Thus, the procedure of propagating at least one input from an mth training pair through the NN 200, comparing the NN output with the associated target output from the mth training pair with a loss function, computing the gradient of the loss function with respect to the edge values, and updating the edge values with a step guided by the gradient is repeated until a termination criterion is reached. Common termination criteria include, but are not limited to, reaching a fixed number of edge updates (otherwise known as an iteration counter), reaching a diminishing learning rate, noting no appreciable change in the loss function between iterations, or reaching a specified performance metric as evaluated on the m training pairs or separate hold-out training pairs (often denoted “validation data”). Once the termination criterion is satisfied, the edge values are no longer altered and the neural network 200 is said to be “trained.”

Turning to a CNN, a CNN is similar to an NN 200 in that it can technically be graphically represented by a series of edges 204 and nodes 202 grouped to form layers 205. However, it is more informative to view a CNN as structural groupings of weights. Here, the term “structural” indicates that the weights within a group have a relationship, often a spatial relationship. CNNs are widely applied when the input also has a relationship. For example, the pixels of a seismic image have a spatial relationship where the value associated to each pixel is spatially dependent on the value of other pixels of the seismic image. Consequently, a CNN is an intuitive choice for processing geological data that includes a seismic image and may include other spatially dependent data.

A structural grouping of weights is herein referred to as a “filter” or “convolution kernel.” The number of weights in a filter is typically much less than the number of inputs, where, now, each input may refer to a pixel in an image. For example, a filter may take the form of a square matrix, such as a 3×3 or 7×7 matrix. In a CNN, each filter can be thought of as “sliding” over, or convolving with, all or a portion of the inputs to form an intermediate output or intermediate representation of the inputs which possess a relationship. The portion of the inputs convolved with the filter may be referred to as a “receptive field.” Like the NN 200, the intermediate outputs are often further processed with an activation function. Many filters of different sizes may be applied to the inputs to form many intermediate representations. Additional filters may be formed to operate on the intermediate representations creating more intermediate representations. This process may be referred to as a “convolutional layer” within the CNN. Multiple convolutional layers may exist within a CNN as prescribed by a user.

There is a “final” group of intermediate representations, wherein no filters act on these intermediate representations. In some instances, the relationship of the final intermediate representations is ablated, which is a process known as “flattening.” The flattened representation may be passed to an NN 200 to produce a final output. Note that, in this context, the NN 200 is considered part of the CNN.

Like an NN 200, a CNN is trained. The filter weights and the edge values of the internal NN 200, if present, are initialized and then determined using the M training pairs and backpropagation as previously described.

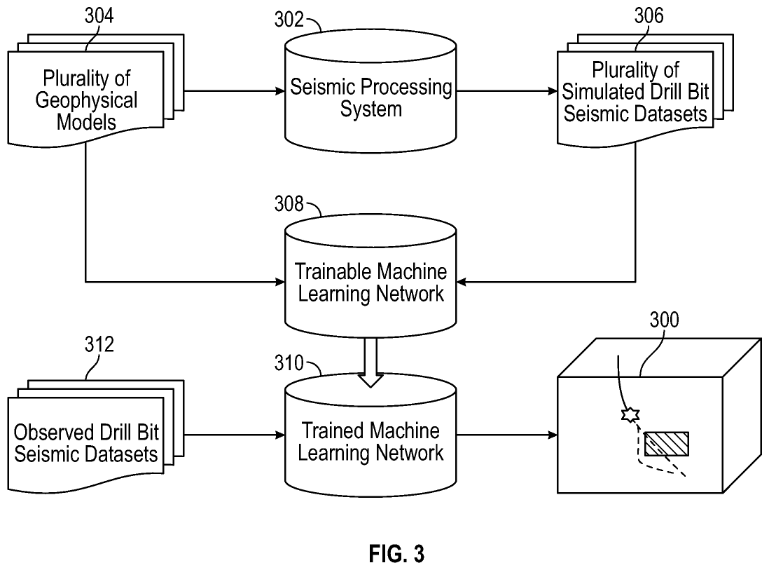

FIG. 3 shows a flowchart in accordance with one or more embodiments. More specifically, FIG. 3 shows a flowchart of using a system for training a trainable machine learning (ML) network to predict a likelihood of a presence of a geological fracture from an observed drill-bit seismic dataset.

In accordance with one or more embodiments, a seismic processing system 302 may be supplied with a plurality of geophysical models 304. Typically, each geophysical model 304 will include a representation of seismic parameters, such as seismic wave propagation velocity and density, throughout the subsurface 124 and include a location of the drill bit 106. In some embodiments, the geophysical model may be specifically designed to resemble the geological structure of a particular portion of a subsurface 124, such as the subsurface beneath the drilling system depicted in FIG. 1. Some of the geophysical models provided to the seismic processing system 302 include geological fractures disposed at one of a variety of locations within the subsurface 124.

The seismic processing system 302 may be used to simulate, for each geophysical model 304, a corresponding simulated drill bit seismic dataset 306 for seismic waves emanating from the drill bit 106 and recorded by at least one seismic receiver 112. The corresponding simulated drill bit seismic dataset 306 may include diffractions from any geological fractures 118 represented in the geophysical model 304.

Each geophysical model 304 and its corresponding simulated drill bit seismic dataset 306 may form a training pair, such that a training dataset may be created from a compilation of training pairs. The training dataset may then be input into a trainable machine learning (ML) network 308. The trainable ML network 308 may then be trained using the training dataset such that the resulting trained ML network 310 may predict a likelihood of a presence of a geological fracture 118 from an observed drill bit seismic dataset 312. The likelihood of a presence may include an estimated location and geometry of the geological fracture. The location and geometry may include at least one of a spatial extent, orientation, and throw, i.e., the amplitude and direction of relative displacement of geological strata on either side of the geological fracture. Further, the likelihood may include measures of the confidence, or uncertainty of the estimate, which may be presented in the form of a probability density function. For example, the likelihood may be presented as a three-dimensional map showing the likelihood of the presence of a fracture at each pixel within a pixelated representation of the subsurface 124.

Once trained, the trained ML network 310 may be applied to an observed drill bit seismic dataset 312 to predict a likelihood 300 of the presence of a geological fracture 118. In cases where a high likelihood of the presence of a geological fracture 118 has been determined, along a not-yet drilled portion of the well trajectory, an updated well trajectory 122 may be planned, using a well planning system to avoid the predicted geological fracture 118.

In one or more embodiments, a data visualization system may be coupled to the trained ML network 310 and the drilling system 100, such that the data visualization system may receive the predicted location of the geological fracture 118 and may plot the location of the geological fracture 118 visually.

In accordance with one or more embodiments, the systems described herein may be implemented using, in part, a computer system, such as the computer system illustrated in FIG. 4. For example, the seismic processing system 302 may include a computer system 402. Similarly, the wellbore planning system and the ML network may be implemented, in some embodiments, on a computers system such as the computer system shown in FIG. 4.

The steps of converting raw seismic data into actionable information about the subsurface is typically divided by workers of ordinary skill in the art into two separate categories. The first category often referred to as “seismic processing” converts raw seismic data into images, usually three-dimensional (3D) images, of the subsurface. These images are typically represented as grids or voxels with one or more value associated with each grid point or voxel. For example, the value may represent a reflection or scattering coefficient at that point in the subsurface, or a seismic wave propagation velocity value at that point.

Seismic processing typically includes subcategories, such as pre-processing, noise attenuation, near-surface corrections, velocity analysis, imaging, and attribute generation. Further seismic processing may involve seismic modeling or simulation as a component of many seismic processing steps.

Pre-processing may include sorting (e.g., “demultiplexing”) and organizing the data (e.g., “common-midpoint sorting”) including integrating the seismic data with geometry and navigation data describing the locations of seismic sources and receivers at the time the seismic data was recorded. Further, pre-processing may include removing (“trace editing”) recordings from malfunctioning receivers, seismic wavelet estimation, correcting amplitudes for geometrical-spreading effects, and deconvolution (e.g., “predictive deconvolution”) to remove undesirable ringing caused by the recording system or the layered structure of the earth.

Seismic noise may include both coherent source-generated and random noise. For example, coherent source-generated may include ground—and mud-roll and both short—and long-period multiple reverberation from the earth. Random noise may include wind or ocean-swell induced noise, anthropogenic noise from nearby machinery (e.g., pumps) or traffic, and may include interference from seismic surveys being conducted in adjacent areas. Noise attenuation may include high-cut filtering of high-frequency noise, removal of surface waves (“ground-roll”) and other linear-propagating noise using frequency-wavenumber (e.g., “f-k” or “tau-p”) filtering, and multiple attenuation.

Near-surface corrections may include correcting for “ghosts” (e.g., deghosting) caused by the proximity of the surface of the earth or sea surface to the seismic sources and receivers, and for near-surface seismic wave propagation velocity and attenuation effects (e.g., “statics-correction”).

In order to determine the correct location of reflectors within the subsurface and generate images of geological structure and seismic attributes, it is necessary to determine the seismic wave propagation velocity at points (a “velocity model”) within the subsurface region of interest. A velocity model may be determined from in-situ measurements, i.e., in a wellbore and/or from the seismic data itself using a process called “velocity analysis”. Various velocity analysis methods are available each with their own computational cost and accuracy characteristics. Velocity analysis may include processes such as “normal-moveout estimation”, “tomography”, and “full waveform inversion” or, frequently, a combination of these methods, all of which are familiar to a person of ordinary skill in the art.

Once a velocity model has been determined, an image of seismic wave reflection or scattering may be determined using a method termed “migration”. As with velocity analysis, there are various methods of migration familiar to a person of ordinary skill in the art, each with its own computation cost and accuracy characteristics. For example, in order of increasing cost and accuracy, migration methods include Kirchhoff Time Migration, Kirchhoff Depth Migration, and Reverse-Time Migration. In each case a migration method aims to position a signal recorded by a seismic receiver at the location in the surface from which it was scattered or reflected.

Seismic processing may produce a number of 3-D images from the seismic data representing different “attributes” of the seismic data. For example, an image of the total amplitude of scattering at each point in the subsurface may be generated. Similarly, the amplitude of scattering within a restricted range of amplitudes may be calculated. Alternatively, the mean, median or mode of the spatial—or temporal-frequency of scattered seismic waves at each point may be imaged. In still other cases, the seismic propagation velocity or seismic propagation attenuation may be used as a seismic attribute.

Although described for convenience above as a linear sequence of steps, a person of ordinary skill in the art will understand that each step of the seismic processing chain is subject to review and quality control (QC) steps of an automatic, statistical, and/or manual nature. For this reason, among others, some seismic processing steps may be repeated immediately or at a later point in the sequence, to produce an improved, refined, or updated result. For example, the seismic velocity model may be updated after an initial migration has been performed. Alternatively, additional temporal-frequency filtering may be inserted into the sequence at numerous points.

Seismic processing may be conducted using a computer system, such as the one shown in FIG. 4. A typical seismic survey dataset may easily be of the order of hundreds of terabytes in size, thus manual seismic processing is essentially impractical and processing a full seismic dataset may require substantial computer resources, including both computer processing and computer memory capabilities. In some embodiments, a seismic processing system may consist of computer hardware components that are specifically configured for the purpose of efficiently performing seismic processing steps. For example, a seismic processing system may typically include an array of computer-processing units (CPUs) with one or more subarrays of graphical processing units (GPUs) attached to each CPU. Tape readers or high-capacity hard-drives may be connected to the CPUs using wide-band data buses. In some cases, the seismic processing system may be co-located with the seismic analyst operating the system, while in other cases the seismic processing system may be implemented remotely from the seismic analysts, such as on “the cloud”, i.e., on computer hardware leased from a third-party at a remote location. In the latter case, the seismic analyst may perform command, control and QC on a local computer system and transmit instructions to and receive summary data from the seismic processing system over a network, including a secure network such as a virtual private network (VPN). A seismic analyst may interface with the seismic processing system on one or more computer monitors where visualization of the seismic data, the results of intermediate processing steps, and/or the final seismic image or attribute image may be displayed. These displays may include perspective visualization of 3D image cubes, planar vertical or horizontal slices, and non-planar surfaces (such as an undulating geological surface). In other cases, the seismic data may be displayed using virtual reality technology (e.g., goggles or “caves”) that allow the seismic analyst to “walk through” the seismic data).

The process of determining geological properties from a seismic image or seismic attribute image is called seismic interpretation. For example, identifying a discontinuity in an otherwise continuous surface of high amplitude seismic reflections as a geological fault, or identifying a region with anomalously high seismic wave attenuation as indicative of a hydrocarbon gas deposit are seismic interpretations. Although, seismic interpretation is generally considered distinct from seismic processing the separation between them is not absolute. For example, additional seismic attributes such as coherence cubes, that measure the similarity of adjacent portions of the seismic image, may be generated during seismic interpretation. Similarly, interpreted geological boundaries may be fed back into the seismic processing chain to improve the focusing of the geological boundary.

Typically, seismic interpretation may have lower computational demands than seismic processing with the exception of the image rendering and display requirements that may be greater for seismic interpretation than for seismic processing. Conversely, the manual interaction with the seismic data may be greater during seismic interpretation than during seismic processing. Seismic processing may include both manual steps, such as “picking” a sparse set of points on a single interpreted undulating geological boundary, and automatic or algorithmic steps, such as picking all the remaining grid points lying on the boundary using the manually picked points as a guide or “seeds”.

Often the output of seismic interpretation includes the seismic image, or attribute image, with the interpretation of labelled geological boundaries, faults, pore fluid contact levels, gas deposits etc., drawn and annotated on the image. In the past such interpretation was performed using displays of portions of the seismic image printed on paper with the interpretation drawn, originally hand-drawn, on the paper using colored pen or pencils. Now, a seismic interpreter of ordinary skill in the art will, almost without exception, use a seismic interpretation workstation to perform seismic interpretation. A seismic interpretation workstation may include one or more computer processor and a computer-readable medium (memory) containing instructions executable by the processor. The computer memory may further contain seismic images and/or seismic attributes. The seismic interpretation workstation may also include a display mechanism, usually one or more monitor screens, but sometimes one or more projector, user-wearable goggles or other virtual reality display equipment and a means of interacting with the display, such as a computer mouse or wand. Further, the seismic interpretation workstation may include dedicated hardware design to expedite the rendering and display of the seismic image, images, or attributes in a manner and at a speed to facilitate real-time interaction between the user and the data. For example, the seismic interpretation workstation may allow the seismic interpreter to scroll through adjacent slices through a 3D seismic image to visually track the continuity of a candidate geological boundary throughout the 3D image. Alternatively, the seismic interpretation workstation may allow the seismic interpreter to manually control the rotation of the view angle of the seismic image so it may be viewed from above, or from the East or from the West, or from intermediate directions.

As for the seismic processing system, the computer processor or processors and computer memory of the seismic interpretation workstation may be co-located with the seismic interpreter, while in other cases the computer processor and memory may be remotely located from the seismic interpreter, such as on “the cloud”. In the latter case, the seismic or attribute images may only be displayed on a screen, including a laptop or tablet, local to the seismic interpreter would may interact with the computer processor via instructions sent over a network, including a secure network such as a virtual private network (VPN).

FIG. 4 depicts a block diagram of a computer system 402 used to provide computational functionalities associated with described algorithms, methods, functions, processes, flows, and procedures as described in this disclosure, according to one or more embodiments. The illustrated computer 402 is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer 402 may include a computer that includes an input device, such as a keypad, keyboard, touch screen, or other device that can accept user information, and an output device that conveys information associated with the operation of the computer 402, including digital data, visual, or audio information (or a combination of information), or a GUI.

The computer 402 can serve in a role as a client, network component, a server, a database or other persistency, or any other component (or a combination of roles) of a computer system for performing the subject matter described in the instant disclosure. The illustrated computer 402 is communicably coupled with a network 430. In some implementations, one or more components of the computer 402 may be configured to operate within environments, including cloud-computing-based, local, global, or other environment (or a combination of environments).

At a high level, the computer 402 is an electronic computing device operable to receive, transmit, process, store, or manage data and information associated with the described subject matter. According to some implementations, the computer 402 may also include or be communicably coupled with an application server, e-mail server, web server, caching server, streaming data server, business intelligence (BI) server, or other server (or a combination of servers).

The computer 402 can receive requests over network 430 from a client application (for example, executing on another computer 402) and responding to the received requests by processing the said requests in an appropriate software application. In addition, requests may also be sent to the computer 402 from internal users (for example, from a command console or by other appropriate access method), external or third-parties, other automated applications, as well as any other appropriate entities, individuals, systems, or computers.

Each of the components of the computer 402 can communicate using a system bus 403. In some implementations, any or all of the components of the computer 402, both hardware or software (or a combination of hardware and software), may interface with each other or the interface 404 (or a combination of both) over the system bus 403 using an application programming interface (API) 412 or a service layer 413 (or a combination of the API 412 and service layer 413. The API 412 may include specifications for routines, data structures, and object classes. The API 412 may be either computer-language independent or dependent and refer to a complete interface, a single function, or even a set of APIs. The service layer 413 provides software services to the computer 402 or other components (whether or not illustrated) that are communicably coupled to the computer 402. The functionality of the computer 402 may be accessible for all service consumers using this service layer. Software services, such as those provided by the service layer 413, provide reusable, defined business functionalities through a defined interface. For example, the interface may be software written in JAVA, C++, or other suitable language providing data in extensible markup language (XML) format or another suitable format. While illustrated as an integrated component of the computer 402, alternative implementations may illustrate the API 412 or the service layer 413 as stand-alone components in relation to other components of the computer 402 or other components (whether or not illustrated) that are communicably coupled to the computer 402. Moreover, any or all parts of the API 412 or the service layer 413 may be implemented as child or sub-modules of another software module, enterprise application, or hardware module without departing from the scope of this disclosure.

The computer 402 includes an interface 404. Although illustrated as a single interface 404 in FIG. 4, two or more interfaces 404 may be used according to particular needs, desires, or particular implementations of the computer 402. The interface 404 is used by the computer 402 for communicating with other systems in a distributed environment that are connected to the network 430. Generally, the interface 404 includes logic encoded in software or hardware (or a combination of software and hardware) and operable to communicate with the network 430. More specifically, the interface 404 may include software supporting one or more communication protocols associated with communications such that the network 430 or interface's hardware is operable to communicate physical signals within and outside of the illustrated computer 402.

The computer 402 includes at least one computer processor 405. Although illustrated as a single computer processor 405 in FIG. 4, two or more processors may be used according to particular needs, desires, or particular implementations of the computer 402. Generally, the computer processor 405 executes instructions and manipulates data to perform the operations of the computer 402 and any machine learning networks, algorithms, methods, functions, processes, flows, and procedures as described in the instant disclosure.

The computer 402 also includes a memory 406 that holds data for the computer 402 or other components (or a combination of both) that can be connected to the network 430. For example, memory 406 can be a database storing data consistent with this disclosure. Although illustrated as a single memory 406 in FIG. 4, two or more memories may be used according to particular needs, desires, or particular implementations of the computer 402 and the described functionality. While memory 406 is illustrated as an integral component of the computer 402, in alternative implementations, memory 406 can be external to the computer 402.

The application 407 is an algorithmic software engine providing functionality according to particular needs, desires, or particular implementations of the computer 402, particularly with respect to functionality described in this disclosure. For example, application 407 can serve as one or more components, modules, applications, etc. Further, although illustrated as a single application 407, the application 407 may be implemented as multiple applications 407 on the computer 402. In addition, although illustrated as integral to the computer 402, in alternative implementations, the application 407 can be external to the computer 402.

There may be any number of computers 402 associated with, or external to, a computer system containing a computer 402, wherein each computer 402 communicates over network 430. Further, the term “client,” “user,” and other appropriate terminology may be used interchangeably as appropriate without departing from the scope of this disclosure. Moreover, this disclosure contemplates that many users may use one computer 402, or that one user may use multiple computers 402.

FIG. 5 depicts a flowchart in accordance with one or more embodiments. More specifically, FIG. 5 depicts a flowchart 500 of a method for training a machine learning (ML) network 308 to a likelihood of a presence of a geological fracture 118 from an observed drill-bit seismic dataset 312. Further, one or more blocks in FIG. 5 may be performed by one or more components as described in FIGS. 1-4. While the various blocks in FIG. 5 are presented and described sequentially, one of ordinary skill in the art will appreciate that some or all of the blocks may be executed in different orders, may be combined, may be omitted, and some or all of the blocks may be executed in parallel. Furthermore, the blocks may be performed actively or passively.

Initially, in step S502, a plurality of geophysical models 304 may be obtained using a seismic processing system 302. Each geophysical model, for example may include a location of the drill bit 106. In one or more embodiments, at least one geophysical model 304 may include a geological fracture 118. In some embodiments, the geophysical model may represent the characteristics of the subsurface 124 beneath the drilling system 100.

In step S504, for each geophysical model 304, the seismic processing system 302 may simulate a corresponding simulated drill bit seismic dataset 306 for seismic waves emanating from the drill bit 106 and recorded by at least one seismic receiver 112. The simulation may be performed by any simulation method known to a person of ordinary skill in the art, without departing from the scope of the invention. For example, the simulation may be performed by finite-difference, or finite-element simulation in either the time-domain or the frequency domain.

In step S504, a training dataset may be formed, where the dataset may include a plurality of training pairs. Each geophysical model 304 and its corresponding simulated drill bit seismic dataset 306 may form a training pair, such that the training dataset may be created from a compilation of each training pair.

In step S508, the ML network 308 may be trained using the training dataset to predict the likelihood of a presence of a geological fracture from the observed drill bit seismic dataset 312. Predicting the likelihood of the presence of a geological fracture may include predicting a location of the geological fracture. Further predicting the likelihood of the presence of the geological fracture may include identifying, using the trained ML network, diffracted seismic waves within the observed drill-bit seismic dataset and migrating, using the seismic processing system the diffracted seismic waves. Migrating the diffracted seismic waves may also include updating a seismic velocity model.

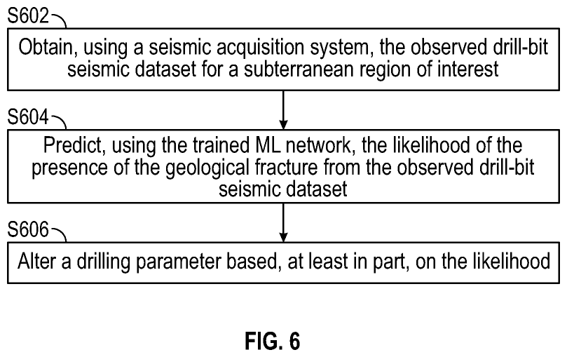

FIG. 6 depicts a flowchart in accordance with one or more embodiments. More specifically, FIG. 6 depicts a flowchart 600 of a method for adjusting drilling parameters based on the method described in FIG. 5. Further, one or more blocks in FIG. 6 may be performed by one or more components as described in FIGS. 1-4. While the various blocks in FIG. 6 are presented and described sequentially, one of ordinary skill in the art will appreciate that some or all of the blocks may be executed in different orders, may be combined, may be omitted, and some or all of the blocks may be executed in parallel. Furthermore, the blocks may be performed actively or passively.

In step S602, an observed drill bit seismic dataset 312 for a subterranean region of interest may be obtained using a seismic acquisition system 108. In one or more embodiments, the seismic acquisition system 108 may include a pilot seismic sensor 110 in acoustic contact with a drillstring 104 attached to a drill bit 106. The seismic acquisition system 108 may further include three-component seismic receivers 112. In one or more embodiments, obtaining the observed drill bit seismic dataset 312 may include cross-correlating a recording from the pilot seismic sensor 110 with raw data recorded by the three-component seismic receivers 112.

In step S604, using the trained ML network 310, the likelihood of the present of a geological fracture 118 may be predicted from the observed drill bit seismic dataset 312. Predicting the likelihood of the presence may include eliminating direct seismic waves and surface seismic waves within the observed drill-bit seismic dataset. Further, in one or more embodiments, predicting the likelihood of the presence may include predicting a location of the geological fracture 118. In one or more embodiments, the predicted location of the geological fracture 118 may be received and plotted by a data visualization system.

The trained ML network 310 may include identifying diffracted seismic waves 120 within the observed drill bit seismic dataset 312 and migrating, using the seismic processing system 302, the diffracted seismic waves 120. identifying diffracted seismic waves 120 may involve using diffraction imaging, seismic migration, or microseismic event location techniques, such as global grid search, amplitude stacking, and semblance. In one or more embodiments, migrating the diffracted seismic waves 120 may include updating a seismic velocity model. Further, predicting the likelihood of the presence of a geological fracture 118 may include eliminating direct seismic waves and surface seismic waves within the observed drill bit seismic dataset 312.

In step S606, a drilling parameter may be altered based, at least in part, on the likelihood of the presence of the geological fracture 118. For example, an original well trajectory 116 may be replaced with an updated well trajectory 122 based on a predicted location of a geological fracture 118. Further, drilling parameters such as drill bit inclination and/or declination, or weight-on-bit may be altered to drill a further portion of the well guided by the updated well trajectory 112. In some embodiments, the drilling mud weight may be adjusted to reduce the potential of a loss circulation event.

Embodiments of the present disclosure may provide at least one of the following advantages. While conventionally used techniques allow for estimation of fracture cluster zones, such techniques cannot identify precise locations of fractures or other hazards near or ahead of the drill bit. Systems and methods disclosed herein allow for real-time location of fractures and other hazards ahead of the drill bit within a subsurface formation and alteration of drilling parameters, such as well trajectory and drilling mud weight, to avoid such hazards. Real-time alterations of drilling parameters reduce the potential of loss circulation events, non-productive time, or complete well loss.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method for training a machine learning (ML) network to predict a likelihood of a presence of a geological fracture from an observed drill-bit seismic dataset, comprising:
obtaining, using a seismic processing system, a plurality of geophysical models, wherein each geophysical model comprises a location of a drill bit;
simulating, using the seismic processing system, for each geophysical model a corresponding simulated drill-bit seismic dataset for seismic waves emanating from the drill bit and recorded by at least one seismic receiver;
forming a training dataset comprising a plurality of training pairs, wherein each training pair comprises a geophysical model from the plurality of geophysical models and the corresponding simulated drill-bit seismic dataset; and
training, using the training dataset, the ML network to predict the likelihood of the presence of the geological fracture from the observed drill-bit seismic dataset.

2. The method of claim 1, further comprising:
obtaining, using a seismic acquisition system, the observed drill-bit seismic dataset for a subterranean region of interest;
predicting, using the trained ML network, the likelihood of the presence of the geological fracture from the observed drill-bit seismic dataset; and
altering a drilling parameter based, at least in part, on the likelihood.

3. The method of claim 1, wherein predicting the likelihood of the presence comprises predicting a location of the geological fracture.

4. The method of claim 1, wherein at least one geophysical model from the plurality of geophysical models comprises a geological fracture.

5. The method of claim 2, wherein the seismic acquisition system comprises three-component seismic receivers.

6. The method of claim 2, wherein the seismic acquisition system further comprises a pilot seismic sensor disposed in acoustic contact with a drillstring attached to the drill bit.

7. The method of claim 6, wherein obtaining the observed drill-bit seismic dataset comprises cross-correlating a recording from the pilot seismic sensor with raw data recorded by three-component seismic receivers.

8. The method of claim 1, wherein predicting the likelihood of the presence further comprises:
identifying, using the ML network, diffracted seismic waves within the observed drill-bit seismic dataset; and
migrating, using the seismic processing system the diffracted seismic waves.

9. The method of claim 8, wherein migrating the diffracted seismic waves comprises updating a seismic velocity model.

10. The method of claim 2, wherein predicting the likelihood of the presence further comprises eliminating direct seismic waves and surface seismic waves within the observed drill-bit seismic dataset.

11. A system for training a machine learning (ML) network to predict a likelihood of a presence of a geological fracture from an observed drill-bit seismic dataset, comprising:
a drilling system comprising a drillstring and a drill bit;
a seismic processing system, configured to:
receive a plurality of geophysical models, wherein each geophysical model comprises a location of the drill bit,
simulate, for each geophysical model a corresponding simulated drill-bit seismic dataset for seismic waves emanating from the drill bit and recorded by at least one seismic receiver, and
form a training dataset comprising a plurality of training pairs, wherein each training pair comprises a geophysical model from the plurality of geophysical models and the corresponding simulated drill-bit seismic dataset;
a ML network, configured to be trained to predict the likelihood of the presence of the geological fracture from the observed drill-bit seismic dataset; and
a seismic acquisition system, configured to obtain the observed drill-bit seismic dataset for a subterranean region of interest.

12. The system of claim 11, wherein the seismic acquisition system comprises three-component seismic receivers.

13. The system of claim 12, wherein the seismic acquisition system further comprises a pilot seismic sensor disposed in acoustic contact with the drillstring attached to the drill bit.

14. The system of claim 13, wherein the seismic acquisition system is further configured to cross-correlate a recording from the pilot seismic sensor with raw data recorded by three-component seismic receivers.

15. The system of claim 11, wherein at least one geophysical model from the plurality of geophysical models comprises a geological fracture.

16. The system of claim 11, wherein the ML network is further configured to predict a location of the geological fracture.

17. The system of claim 16, further comprising a data visualization system configured to receive the location of the geological fracture and to plot the location of the geological fracture.

18. The system of claim 11, wherein the ML network is further configured to identify diffracted seismic waves within the observed drill-bit seismic dataset.

19. The system of claim 18, wherein the seismic processing system is further configured to migrate the diffracted seismic waves.

20. The system of claim 19, wherein the seismic processing system is further configured to update a seismic velocity model.
